(19) United States
(12) Patent Application Publication
(10) Pub. No.: US 2026/0017727 A1
(43) Pub. Date: Jan. 15, 2026

(54) SALARY MANAGEMENT DEVICE AND METHOD THEREFOR

(71) Applicant: Hyung Chul KIM, Yeongdo-gu (KR)

(72) Inventor: Hyung Chul KIM, Yeongdo-gu (KR)

(21) Appl. No.: 18/692,738

(22) PCT Filed: Sep. 15, 2022
(86) PCT No.: PCT/KR2022/013758

§ 371 Date: Jun. 24, 2025

(30) Foreign Application Priority Data
Sep. 16, 2021 (KR) 10-2021-0124201
Nov. 3, 2021 (KR) 10-2021-0150053

(51) Int. Cl. G06Q 40/12; G06Q 10/105; G06Q 10/1091

(52) U.S. Cl. CPC G06Q 40/125; G06Q 10/105; G06Q 10/1091

(57) ABSTRACT

A salary management device and a method therefor are disclosed. The present invention allows salaries to be automatically distributed by wage category by using a circular reference function on the basis of total salary according to user input and extended hours according to work hours in an automatically converted numeric format, and thus the salaries can automatically be distributed by wage category within a range not exceeding the total amount of monthly salary inputted by the user, so that the monthly salary amount initially expected by the user cannot be exceeded, the resulting value can be checked in real time so that the user can set work hours and salary as desired, the program setting time is shortened, and the user can self-set without expert help.

### FIELD OF INVENTION

This invention pertains to financial management systems, particularly a novel salary management device and method. It automates salary allocation into predetermined categories via a circular reference function that adjusts salary distributions based on user-inputted total salary and overtime calculations from numerically adjusted work hours.

### BACKGROUND ART

The Labor Standards Act sets the foundational legal framework for minimum working conditions to protect workers' rights, aligning with constitutional safeguards for their livelihood.

According to the Labor Standards Act, employers commonly use software like Excel to calculate working hours and determine salaries. Yet, these tools, which use a 24-hour time format, often lead to inaccuracies when working hours exceed 24:00.

Additionally, existing payroll systems require detailed input data, such as working hours and days worked, for result verification. This can lead to errors requiring program recalibration. The setup process, without guidance from experts like labor lawyers, is challenging and inefficient. Identifying suitable payroll software is time-consuming, and structural flaws in these systems can cause employers to unintentionally exceed their budget for monthly salaries.

The invention aims to introduce a salary management device and method that automatically allocates salaries into defined categories through a circular reference function, calculating distributions based on user-inputted total salary and overtime from numerically formatted working hours.

This invention also seeks to provide a device and method for converting employees' digital clock-in and clock-out times into numeric working hours in compliance with the Labor Standards Act.

Another goal of invention is to feature a salary management device and method capable of assessing adherence to the Labor Standards Act's legal standards using total salary, overtime from numerically adjusted working hours, and categorized wages.

In an embodiment of the present invention, a salary management device is equipped with a display unit that not only showcases an application execution result screen but also, upon selection of a predefined working time conversion menu from the said screen, transitions to a working time conversion screen which facilitates the transformation of working hours from a digital display format into a numerical format by importing and displaying the contents of a file selected by the user on one side of the screen, while simultaneously, its control unit is designed to ascertain the occurrence of any infringements of regulations specified in the Labor Standards Act based on the converted daily working hours, thereafter displaying both the pertinent information regarding potential violations and the converted daily working hours on the display unit.

Within an illustrative embodiment of the instant invention, in instances where the evaluation conducted by the control unit identifies compliance with the legal mandates prescribed by the Labor Standards Act, such that no infringements are detected, the control unit is adept at instructing the display unit to present data affirmatively signifying the non-existence of any legal infractions, in conjunction with showcasing the numerically transformed daily working hours.

In a specific embodiment pertinent to the subject invention, should the assessment executed by the control unit disclose any transgressions of the legal directives as outlined in the Labor Standards Act, said control unit possesses the capability to command the display unit to render visible the particulars concerning the identified legal contravention along with details of the daily working hours post-conversion.

In accordance with embodiments of the current invention, the salary management method involves a sequence of operations where, initially, upon user engagement with a predetermined working time conversion menu on the application execution result screen, the control unit fetches a user-selected file, subsequently revealing a working time conversion interface on the display unit to facilitate the transformation of work time data from digital to numerical format; this process further extends to when a preset import menu is activated on the said screen, prompting the control unit to import and exhibit data from one or more user-selected files from the storage unit onto one portion of the working time conversion interface, and, following the selection of a preset conversion menu, the control unit then transfigures the digital-format daily working time data from the shown file into numerical working hours, thereafter assessing for any transgressions against the Labor Standards Act's legal directives based on these numerically converted working hours, and, ultimately, it manifests on the display unit details regarding any discerned violations alongside the numerically transformed daily working hours.

Within an illustrative embodiment of the current invention, the methodology for transmuting daily working time data from a file's digital display format into numerical working hours encompasses a computation that is initiated when the hour value denoting the clock-in time within the working time data surpasses the hour value indicative of the clock-out time, whereby the calculation of working hours is executed according to the formula: hours of working time=c−a−1, and minutes of working time=60−b+d, with ‘a’ signifying the clock-in time's hours, ‘b’ indicating the clock-in time's minutes, ‘c’ denoting the clock-out time's hours, and ‘d’ representing the clock-out time's minutes.

Within an exemplar scenario of this invention, the transformation of daily working time data from a digital display format within a file to numerical working hours commences when the clock-in time's numerical value is less than or equal to the clock-out time's numerical value, leading to a calculation that determines working hours with the mathematical formulation: hours of working=c−a, and minutes of working=d−b, where ‘a’ and ‘b’ denote the hour and minute of the clock-in time, respectively, while ‘c’ and ‘d’ correspond to the hour and minute of the clock-out time.

In another embodiment pertinent to this invention, converting daily work time information from a digital to a numerical format encompasses special provisions for scenarios like night shifts or overtime, wherein if the clock-out time, due to night work or overtime, deviates from the clock-in time causing a negative result in calculated working hours, a specific preset value is appended to this negative outcome, with the aggregate of these figures thereafter delineated as the total working hours.

An embodiment of the Salary Management Device under this invention comprises a display unit that unfurls a salary distribution interface, systematically channeling salaries into assorted salary categories grounded on overtime and aggregate salaries deduced from the numeric working hours of each employee, this operation initiates upon the selection of a designated salary distribution menu from the outcome screen of the application, managed by a control unit that supervises the automated dispersal of salaries based on the user-input total monthly salary and overtime across predefined salary categories, while also evaluating adherence to the stipulations of the Labor Standards Act by displaying pertinent compliance information and any detected violations directly on the display unit.

The Salary Management Method, as detailed in embodiments of this invention, encompasses the initiation of a salary distribution screen on the display unit, enabling the automatic allotment of salaries among diverse salary categories through the utilization of a circular reference function, an operation initiated upon selection of a predefined salary distribution menu from the application execution result screen; thereafter, upon user input of the total monthly salary and extended time within the salary distribution screen, supervision of the automatic salary distribution across salary categories via the circular reference function is carried out by the control unit, which further conducts assessments to identify potential violations of additional laws stipulated by the Labor Standards Act, considering factors including total salary, overtime, and various wage elements, with subsequent display of information concerning the automatically dispensed wages and any detected legal infractions on the display unit.

An exemplary instance related to this invention involves the automated distribution of salaries to salary categories using a circular reference function based on the total monthly salary and overtime, where various salary components such as basic salary, extension allowance, weekly holiday allowance, and regular hours are calculated through multiple equations, including gross monthly salary minus extension allowance minus weekly allowance, extension allowance minus regular hourly wage multiplied by extension time multiplied by 1.5, weekly holiday allowance minus regular hourly wage multiplied by 8, and regular hourly wage minus basic salary divided by 209.

### Effects of the Invention

By automatically distributing salaries to salary categories using a circular reference function based on total monthly salary input by the user and overtime in an automatically converted numerical format, the present invention ensures that salaries are distributed within the user-defined total monthly salary limit, facilitating real-time verification of results, enabling users to customize working hours and salary preferences, reducing program setup time, and allowing user self-configuration without expert assistance.

Also, the invention simplifies compliance with legal standards mandated by the Labor Standards Act by directly converting workers' arrival and departure times into numerical working hours, enabling immediate verification without conversion processes, accommodating complex working hour calculations including those beyond 24 hours and shift hours, facilitating direct checks on weekly, monthly, and yearly working hour totals without conversion, and enabling versatile formula combinations using numerical time concepts without conversion.

Also, by examining potential violations of Labor Standards Act regulations based on total monthly salary, automatically converted overtime, and detailed wage item penalties, the invention provides real-time guidance on legal compliance, thereby preempting unexpected violations even after setup completion.

### BRIEF DESCRIPTION OF THE DRAWING

FIG. 1 depicts a block diagram describing the configuration of a salary management device according to an embodiment of the present invention.

FIG. 2 presents a flowchart describing a salary management method according to an embodiment of the present invention.

FIGS. 3 through 9 describe examples of screens according to embodiments of the present invention.

### BEST MODE FOR CARRYING OUT THE INVENTION

It is important to note that the technical terms utilized in this invention are solely employed to describe specific embodiments and are not intended to restrict the scope of the invention. Moreover, these technical terms should be interpreted in a manner commonly understood by those skilled in the relevant technical field, without excessively broad or narrow interpretations, unless explicitly defined otherwise in the invention. Furthermore, any incorrect technical terms used herein should be replaced with terms accurately comprehensible to those skilled in the art. Additionally, general terms should be construed according to their standard definitions or within the context provided, avoiding overly restrictive interpretations.

Also, singular expressions in this invention encompass plural forms unless explicitly indicated otherwise. Terms such as “consisting of” or “including” should not be interpreted as necessarily comprising all components or steps described in the invention; some may be excluded, and additional components or steps may be included.

Also, ordinal terms like “first” or “second” used herein are for descriptive purposes and should not limit the components they describe. These terms serve only to differentiate one component from another, allowing flexibility in their naming without deviating from the scope of the present invention.

Also, in the explication of the present invention, should it become apparent that the inclusion of an exhaustive exposition of art known in the public domain might detract from the clarity or core essence of the invention, such detailed exposition shall be omitted. It is also imperative to underscore that the diagrams and figures provided herein are intended exclusively for the facilitation of understanding the present invention's principles and are not to be interpreted as limiting the scope of the invention to the particular representations depicted therein.

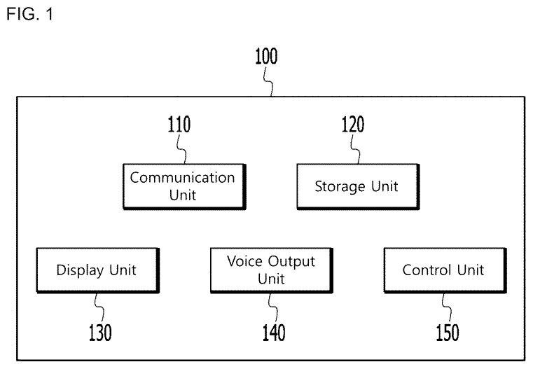

FIG. 1 describes a block diagram delineating the architecture of a salary management device 100 in accordance with embodiments of the present invention.

The salary management device (100) encompasses a variety of terminals including, but not limited to, smartphones, portable terminals, mobile terminals, foldable terminals, personal digital assistants (PDAs), Portable Multimedia Player (PMP) terminals, telematics terminals, navigation terminals, personal computers, laptop computers, slate PCs, tablet PCs, ultrabooks, wearable devices (such as smartwatches, smart glasses), Head Mounted Displays (HMDs), WiBro terminals, Internet Protocol Television (IPTV) terminals, smart TVs, digital broadcasting terminals, Audio Video Navigation (AVN) terminals, Audio/Video (A/V) systems, flexible terminals, and digital signage devices. In this context, the salary management device (100) may be any terminal possessed by a user (or salary manager) seeking to execute salary management functions.

The communication unit (110) facilitates communication with any internal component or at least one external terminal via a wired or wireless communication network. The external terminal may include, but is not limited to, a server (not depicted) or a terminal (not depicted). Wireless internet technologies that may be utilized encompass Wireless LAN (WLAN), Digital Living Network Alliance (DLNA), Wireless Broadband (WiBro), World Interoperability for Microwave Access (WiMax), High Speed Downlink Packet Access (HSDPA), High Speed Uplink Packet Access (HSUPA), IEEE 802.16, Long Term Evolution (LTE), Long Term Evolution-Advanced (LTE-A), and Wireless Mobile Broadband Service (WMBS). The communication unit (110) is capable of transmitting and receiving data according to at least one wireless internet technology, including those not explicitly listed. Short-range communication technologies may include Bluetooth, Radio Frequency Identification (RFID), Infrared Data Association (IrDA), Ultra Wideband (UWB), ZigBee, Near Field Communication (NFC), Ultrasound Communication (USC), Visible Light Communication (VLC), Wi-Fi, Wi-Fi Direct, among others. Additionally, wired communication technologies may involve Power Line Communication (PLC), USB communication, Ethernet, serial communication, and optical/coaxial cables.

Also, the communication unit (110) is capable of bi-directionally transmitting information to and from any terminal via a Universal Serial Bus (USB).

Also, the communication unit (110) utilizes various technical standards and communication methods for mobile communications, including but not limited to GSM (Global System for Mobile Communication), CDMA (Code Division Multiple Access), CDMA2000 (Code Division Multiple Access 2000), EV-DO (Enhanced Voice-Data Only), WCDMA (Wideband CDMA), HSDPA (High Speed Downlink Packet Access), HSUPA (High Speed Uplink Packet Access), LTE (Long Term Evolution), and LTE-A (Long Term Evolution-Advanced). It exchanges radio signals with base stations, servers, and terminals on mobile communication networks established in accordance with these standards.

Also, under the supervision of the control unit (150), the communication unit (110) transmits a file containing worker information, daily working time details in digital or numeric formats, such as start and end times, to servers or terminals.

The storage unit (120) is responsible for housing various user interfaces (UI), graphical user interfaces (GUI), and similar components.

Additionally, the storage unit (120) holds data and programs essential for the operation of the salary management device (100).

The storage unit (120) of the present invention is configured to house an extensive array of application programs, data, and operational instructions essential for the operational efficacy of the salary management device (100). A portion of these applications can be procured via wireless transmission from external server sources, while a subset is inherently integrated within the device prior to distribution, thereby enabling fundamental functionalities. These applications, once domiciled within the storage unit (120), are instituted on the salary management device (100) and subsequently mobilized by the control unit (150) for the facilitation of the device's diverse functionalities.

In addition, the storage unit (120) accommodates an assorted compilation of storage mediums, such as flash memory, hard disk drives, micro multimedia cards, various card-type memories (for instance, SD or XD memory cards), magnetic disks, optical disks, as well as various forms of memory including RAM (Random Access Memory), SRAM (Static Random Access Memory), ROM (Read-Only Memory), EEPROM (Electrically Erasable Programmable Read-Only Memory), and PROM (Programmable Read-Only Memory). Furthermore, the salary management device (100) is equipped to utilize web storage capabilities, either as a standalone storage solution or in synergy with cloud-based storage services.

Also, the storage unit (120), under the guidance of the control unit (150), retains files containing worker information, daily work schedules presented in digital or numerical formats (e.g., start and end times), and related data.

The display unit (130) of the disclosed invention is capable of rendering a wide spectrum of content, which includes, but is not limited to, assorted menu interfaces employing both stored user interface designs and graphical user interface elements retrieved from the storage unit (120) under the governance of the control unit (150). The range of content displayable by the display unit (130) extends to textual information, graphical image data, and menu interfaces adorned with user interaction elements such as icons, list menus, combo boxes, among others. In addition, the display unit (130) is capable of integrating touch-screen capabilities, thereby enhancing user interaction and operational convenience.

Also, the display unit (130) boasts a versatile range of display technologies, including but not limited to liquid crystal displays (LCD), thin film transistor-liquid crystal displays (TFT LCD), organic light-emitting diodes (OLED), flexible displays, 3D displays, electronic ink displays, and light-emitting diodes (LEDs).

Also, the display unit (130) dutifully showcases data (or information) from a file containing worker information, daily work schedules in digital display format (or digital type format), and daily work hours in numerical format (or numerical display format), all orchestrated by the control unit (150).

The voice output unit (140) efficiently disseminates audio information embedded within signals processed by the control unit (150). This unit may encompass a receiver, speaker, buzzer, or equivalent components.

Moreover, the voice output unit (140) emits articulate guidance voices meticulously generated by the control unit (150).

Furthermore, under the governance of the control unit (150), the voice output unit (140) conveys voice information (or sound information) corresponding to the data (or information) contained in a file, which includes worker information, daily work schedules in digital display format (or digital format) (such as start and end times), and daily work hours in numerical format (or numerical display format).

The controller (or MCU-microcontroller unit) (150) adeptly oversees the comprehensive control operations of the salary management device (100).

Also, the control unit (150) adeptly executes the comprehensive control functions of the salary management device (100), utilizing programs and data stored in the storage unit (120). This unit, comprising RAM, ROM, CPU, GPU, and interconnected via a bus, allows access to the storage unit (120) for booting using the O/S stored therein and executing various operations with diverse programs, content, and data.

Also, the control unit (150), in collaboration with the server, etc., facilitates user registration to access functionalities such as file import, working hours conversion, and automatic salary distribution by salary category through a dedicated application and/or website. Personal information required for registration includes username, email address, password (or passphrase), name, gender, date of birth, contact number (or phone number), and address.

Also, the control unit (150) may utilize SNS account information or mobile messenger account details provided by the user of the salary management device (100) to register the user as a member of the server or similar platforms. SNS accounts may encompass platforms like Facebook, Twitter, Kakao Story, Naver, PAYCO, among others. Similarly, mobile messenger accounts may pertain to KakaoTalk, Line, Viber, WeChat, WhatsApp, Telegram, Snapchat, etc.

Also, throughout the membership registration process, the control unit (150) guarantees the fulfillment of the authentication step through self-authentication methods, including mobile phone verification, credit card authentication, or i-PIN verification, which are crucial for ensuring accurate registration with the server or analogous platforms.

Also, post membership registration, the control unit (150) proceeds to install a dedicated application (or feature app) provided by the server or similar platforms onto the relevant salary management device (100). This dedicated application is tailored to execute functions like file loading, working hours conversion, and automatic salary distribution by salary category, enhancing user experience and utility.

Also, the control unit (150), upon initializing the proprietary application preloaded on the salary management device (100), displays the resultant interface of said application execution on the display unit (130), encompassing various functionalities including, but not limited to, a working hours conversion menu facilitating the importation of files encapsulating employee working hours in a digital format and their subsequent conversion into a numerical representation of working hours. In addition, this interface provides access to a salary distribution menu, utilizing a circular reference function to effectuate the automated allocation of salaries into predefined categories, contingent upon calculated overtime and the aggregate monthly compensation per employee. The interface further features a settings menu, enabling the customization of the application's operations. The control unit (150) possesses the capability to enroll as a user on a server (not illustrated) that hosts the proprietary application, subsequently accessing the application via a sign-in procedure utilizing credentials such as a user ID and password established during the user registration phase, or alternatively, through scanning a barcode or QR code linked to the user ID. Through the initiation of the sign-in process, the control unit (150) is thereby enabled to activate various functions within the proprietary application, including, but not limited to, the importation of files, the conversion of working hours, and the automated distribution of salaries according to specific salary categories.

Also, upon selection of the designated working hours conversion menu from the application's execution outcome screen as depicted on the display unit (130), the control unit (150) retrieves a file according to user specification and renders a working hours conversion interface on said display unit (130). This interface is engineered to transmute the digital representation of working hours into a numerical format through the ingestion of a file. Incorporated within this interface are functionalities such as an import menu for the retrieval of pre-existing files, a conversion menu dedicated to the transformation of digitally formatted arrival and departure times into numerical working hours, and a save menu designed for the preservation of these numerically converted working hours. By default, functionalities including the conversion menu and save menu are initially set to an inactive status; nevertheless, subsequent to the acquisition of a file via the import menu and its subsequent exhibition on the display unit 130, these functionalities are enabled to transition from an inactive state to an active one, thereby facilitating the comprehensive processing of working hours.

Also, upon selection of a prearranged import menu on the working time conversion interface exhibited on the display unit (130), the control unit (150) initiates the retrieval of one or more files stored in the storage unit (120) in accordance with user selection (or user input/touch/control). Subsequently, the control unit (150) showcases the data (or information) encapsulated within the loaded file on one side of the working time conversion interface displayed on the display unit (130). These files, which may assume the form of databases such as Excel files, Access files, etc., encompass worker particulars (e.g., full name/worker name, partial social security number, employee code, etc.) alongside daily working time details (e.g., including arrival time/start time, departure time/end time, etc.).

Also, upon selection of a predefined conversion menu on the working time conversion interface presented on the display unit 130 (or when the conversion menu is selected while the data from the imported file is displayed on the display unit 130), the control unit (150) undertakes the conversion of daily working time information (comprising arrival time, departure time, etc.) in digital display format from the respective file displayed on one side of the working time conversion interface into numerical working hours.

In essence, upon activation of a predetermined conversion menu on the working time conversion interface exhibited on the display unit (130), the control unit (150) conducts the computation (or calculation/conversion) of numerical working hours predicated on the daily arrival and departure times in digital display format for each worker featured in the aforementioned loaded file, utilizing the equations denoted as [Equation 1] and [Equation 2].

$$b > If d , working hours = c - a - 1 , working hours = 60 - b + d \qquad [ Formula 1 ]$$

$$If bSd , working hours = c - a , working hours = d - b \qquad [ Equation 2 ]$$

In this context, variable ‘a’ denotes the hour of arrival at the workplace, ‘b’ signifies the minute of arrival at the workplace, ‘c’ stands for the hour of departure from work, and ‘d’ indicates the minute of departure from work. It is important to note that each of these variables, namely ‘a’, ‘b’, ‘c’, and ‘d’, can take on values from the set of natural numbers.

Additionally, if the calculated working time yields a negative value due to night shifts or overtime work, and the departure time is on a different day than the arrival time, the control unit (150) compensates by adding a predetermined value (e.g., 24) to the negative working time and considers the resulting sum as the time for the corresponding working period.

Specifically, if the calculated working time turns out negative due to night shifts or overtime work, where the departure time differs from the arrival time, the control unit (150) adjusts the formulas in the preceding equations. In Equation 1, it transforms “hours of working time=c−a−1” into “hours of working time=24+c−a−1,” and in Equation 2, it alters “hours of working time=c−a” to “hours of working time=24+c−1.” These modifications enable the calculation of the hours for the corresponding working period using the adjusted formulas.

Accordingly, the control unit (150) is configured to calculate the working hours in accordance with the parameters delineated in [Equation 1] and [Equation 2], accommodating the computation of hours for both standard daytime shifts and nocturnal work periods.

Furthermore, the control unit (150) is designed to transform the digital-format clock-in and clock-out times, expressed in hours and minutes, into their numerical counterparts.

In a similar vein, the control unit (150) is capable of converting employee working time data, presented in a digital display format (e.g., 08:00, 22:00), into a quantified numerical representation, such as 8 hours per day, 40 hours per week, or 52 hours per week, thereby facilitating a more standardized accounting of labor hours.

Consequently, when employing digital data display formats, such as Excel, for time representation, certain computational discrepancies may emerge, potentially leading to inaccuracies in the calculated working hours. For example, complications may arise in scenarios where the work period exceeds the conventional 24:00 threshold, as observed when a shift commences at 22:00 and concludes at 05:00 the following day. Additionally, aggregating total working hours that surpass a 24-hour period, as in instances of accruing 8 hours on consecutive days, may inadvertently result in a miscalculated cumulative duration of 16:00 rather than the accurate aggregate of 40 hours.

Also, by integrating digital and numerical display formats during salary calculations, errors inherent in standalone digital formats are effectively resolved. For instance, errors arising from multiplying 08:00 in digital display format by an hourly wage of 10,000 won in numerical format are mitigated, ensuring accurate calculations, such as 8 hours in numerical format multiplied by the hourly wage in numerical format yielding 80,000 won.

Also, by selecting a predetermined storage option on the working time conversion screen shown on the display unit (130), the control unit (150) updates the file by adding a new tab or item, into which the converted daily work hours are inserted, and then stores the updated file in the storage unit (120) or a specified storage location/folder within the salary management device (100).

Within the illustrated embodiments of this invention, the control unit (150) is designed to convert daily arrival and departure times from digital display format to numerical working hours upon selecting a conversion menu after a file has been loaded, yet importantly, this transformation process is not exclusively bound to this order; alternatively, the control unit (150) has the capability to convert the times into numerical working hours in the background immediately after a file is selected and loaded, with the additional functionality of simultaneously displaying both the converted working hours and the original contents of the loaded file on the display unit (130).

Also, the control unit (150) assesses whether any breaches of the labor laws mandated by the preset Labor Standards Act have occurred based on the converted daily working hours. These legal infractions include determining whether the weekly work hours surpass 40 hours and 52 hours, respectively, in compliance with an 8-hour workday.

Also, the control unit 150 is configured to present information regarding compliance with the Labor Standards Act and the converted daily working hours (or their numerical equivalents) on the display unit (130).

Stated otherwise, in the event that the assessment (or verification result) reveals no infringements of the Labor Standards Act, the control unit (150) updates and displays information that signifies the non-existence of violations, alongside the numerically converted daily working hours and pertinent details, on the working time conversion interface.

Also, in the event of a determination (or verification) indicating a breach of the Labor Standards Act, the control unit (150) updates and exhibits details regarding the violation, the converted daily working hours, and associated information on the working time conversion screen.

Also, upon selecting a predefined salary distribution menu from the application execution result screen displayed on the display unit (130), the control unit (150) presents a salary distribution interface designed to automatically allocate wages across salary categories based on overtime hours and total monthly salary (or overall salary) corresponding to the work hours of individual workers. This salary distribution screen encompasses various elements, including worker information input fields for displaying worker details, total monthly salary input fields for entering total monthly earnings, overtime input fields for specifying overtime hours, multiple wage items computed automatically via circular reference functions utilizing overtime and total salary inputs, and a legal violation indicator for highlighting compliance with the Labor

Standards Act. Notably, if another file is chosen from among multiple files stored in the storage unit (120), the control unit (150) autonomously loads worker information from the selected file, which can be displayed in the worker information input fields. Also, the control unit (150) automatically calculates overtime hours based on the numerical daily work hours for each worker from the selected file and displays (or inputs) the calculated overtime hours in the designated input field. Importantly, the control unit (150) may opt to withhold the display of worker information in the worker information input fields.

Also, upon user input of the gross monthly salary and overtime hours in the total monthly salary input field and overtime hours input field, respectively, within the salary distribution screen (or upon automatic input of overtime hours followed by user input of the gross monthly salary in the total monthly salary input field), the control unit (150) performs automatic salary distribution across salary categories using circular reference functions based on the user inputs as per Equations 3 to 6.

Here, the multiple wage items include a basic salary item, an overtime allowance item, a weekly holiday allowance item, and a normal hourly pay item.

In other words, when the total monthly salary and overtime time are input according to the user input in the total monthly salary input and overtime input in the salary distribution screen (or after the overtime is automatically input in the overtime input item, the control unit (150) calculates the basic salary, the on-site allowance, the weekly allowance, and the normal hourly pay for the total monthly salary and the overtime input by the worker included in the imported file using the circular reference function.

$$Basic salary ( bb ) Total monthly salary ( aa ) - Extension allowance ( cc ) - Weekly holiday allowance ( dd ) \qquad [ Equation 3 ]$$

$$Extension allowance ( cc ) - Normal hourly pay ( ee ) \times Extension Time ( // ) \times 1.5 \qquad [ Form 4 ]$$

$$Weekly holiday allowance ( dd ) Regular hourly wage ( f ) \times 8 \qquad [ Equation 5 ]$$

$$Normal hourly pay ( // ) - Basic wage / 209 \qquad [ Form 6 ]$$

Also, the control unit (150) checks (or determines) whether there are other violations of laws required by the preset Labor Standards Act based on the total monthly salary, the overtime, the plurality of wage items, etc. Here, the other violations of the law include compliance with the normal hourly pay (for example, the minimum wage of 8,720 won as of 2021).

Also, the control unit (150) displays information on the display unit (130) on the by-salary category salary (or amount) automatically allocated according to the total monthly salary and overtime according to the user input, and other violations of the law required by the Labor Standards Act.

In other words, if there is no other violation of the law required by the Labor Standards Act, the control unit (150) updates and displays information indicating that there is no violation of the law and the distributed by-salary category amount on the salary distribution screen.

In addition, if there are any other violations of the law required by the Labor Standards Act, the control unit (150) updates and displays information on violations of the law and the distributed by-salary category on the salary distribution screen.

Consequently, to authenticate outcomes such as the regular hourly wage amount, minimum wage violations, and infractions of the 52-hour workweek mandate, it is imperative to input all essential data, including prevailing working hours and salaries; inaccuracies in these inputs necessitate frequent program resets, and configuring the program without guidance from labor experts presents significant hurdles, yet despite these challenges, the control unit (150) adeptly administers the comprehensive salary distribution across various wage items by leveraging the aggregate salary and overtime through a circular reference function.

Also, in this manner, the control unit (150) can promptly assess the outcome throughout the salary configuration process and may be structured to prevent unforeseen overpayments by ensuring that the salary is automatically distributed within the expected range set by the configurator (or employer).

Additionally, since the aforementioned control unit (150) can modify the configurations by choosing between the total monthly salary (or total salary) and the working hours (e.g., opting to increase the salary if it falls below the minimum wage or reduce the working hours), the scope of salary configuration may be broadened.

The embodiments of the current invention contemplate basic wages, extension allowances, weekly holiday allowances, normal hourly pay, etc., concerning wage items. However, the invention is not confined to these elements. The control unit (150) may distribute the salary by salary category, taking into account factors such as the number of workers (e.g., less than 150 employees, more than 150 employees, more than 150 employees but less than 1000 employees, over 1000 employees, etc.) and the four premiums (e.g., national pension, health insurance, employment insurance, and industrial accident insurance). In this scenario, the preceding Equations 3 to 6 may be adjusted considering the four premiums.

Also, although the embodiments detailed herein primarily focus on the automatic distribution of salaries in relation to wage items based on user-provided data (such as gross wages and overtime) as stipulated by labor laws through the salary management device (100), this application is not solitary; the same device (100) is versatile enough to facilitate financial and accounting calculations incorporating tax laws, commercial regulations, and other legal frameworks, in addition to executing computations pertinent to a hospital's NET (No Extra Taxes) system, all predicated on the information input by the user.

Moreover, the embodiments of this invention detail that the salary management device (100) executes operations including file retrieval, conversion of working hours, and the automated categorization and distribution of salaries via a specialized application; however, these functions are not limited to application-based execution alone, as they can also be performed through a server-hosted website, complementing the functionalities offered by the dedicated application.

Thus, the automatic distribution of salaries to various salary categories is facilitated through a circular reference function, leveraging both the total salary input by the user and the overtime calculated based on the converted numerical representation of working hours.

Also, this approach enables the conversion of workers' clock-in and clock-out times, presented in digital format, into numerical working hours compliant with the regulations stipulated in the Labor Standards Act.

Also, this methodology allows for the verification of compliance with the Labor Standards Act by cross-referencing various parameters such as the total monthly salary, overtime calculated from automatically converted numerical working hours, and the distribution of salary by salary category.

Subsequently, a detailed description of the salary management method in accordance with the present invention will be elucidated with reference to FIGS. 1 through 9.

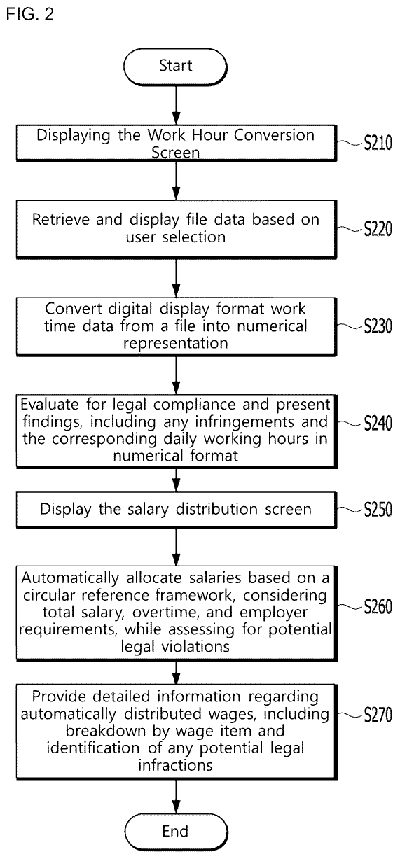

Illustrated in FIG. 2 is a flowchart delineating the steps of the salary management method as per embodiments of the present invention.

Initially, the control unit (150) initiates the execution of a dedicated application pre-installed on the relevant salary management device (100) and presents the outcome of the application execution on the display unit (130). The displayed result encompasses functionalities such as importing files containing working hours in digital format and converting them into numeric working hours, a menu for automatically distributing salary to various salary categories utilizing a circular reference function based on overtime and total monthly salary per worker's working hours, and configuration settings for the dedicated application. The control unit (150) may access these features by registering as a member of a server (not depicted) offering the dedicated application and undergoing a login process utilizing credentials obtained through membership registration, or via scanning a barcode or QR code containing membership information. This facilitates the execution of one or more functions of the dedicated application, including but not limited to, file loading, working hours conversion, and automatic salary distribution by salary category.

Also, upon selection of the predefined working hours conversion menu from the application execution result screen presented on the display unit (130), the control unit (150) undertakes the task of retrieving a file as per the user's choice. Subsequently, it showcases a working time conversion screen on the display unit (130), aimed at converting the working hours represented in a digital format into numerical format. This screen encompasses essential features such as an import menu for fetching a stored file, a conversion menu for translating the daily arrival and departure times from the imported file into numerical working hours, a save menu for preserving the converted daily working hours, and similar functionalities. Initially, the conversion menu, save menu, and related options remain inert but transition to an activated state after the file loading process, where the contents of the file are exhibited on the display unit (130).

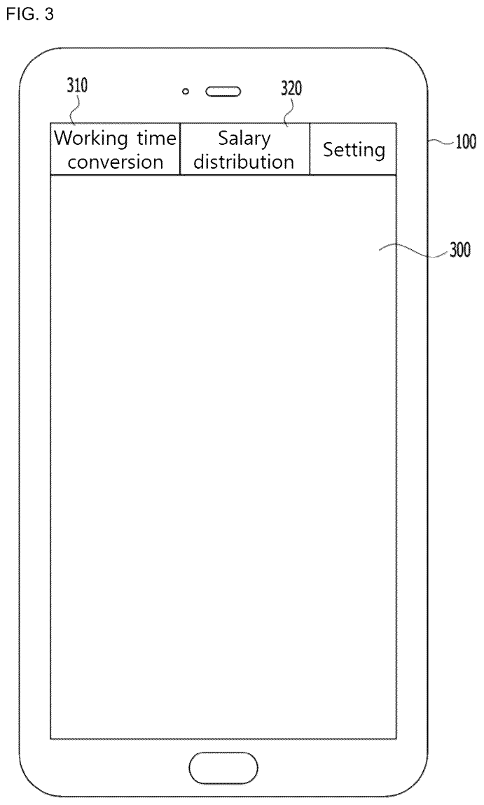

As an illustrative instance, the primary control unit (150) executes a pre-installed salary management application on the corresponding first salary management device (100). Subsequently, as depicted in FIG. 3, the outcome of the salary management application execution, denoted by the salary management app execution result screen (300), is displayed on the first display unit (130).

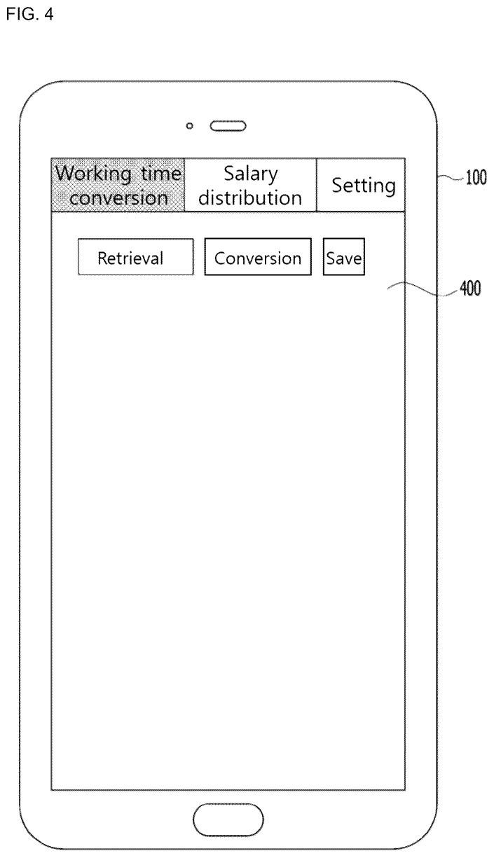

Also, upon selection of the working hours conversion menu (310) from the salary management app execution result screen (300) showcased on the first display unit, the first control unit orchestrates the presentation of a corresponding working time conversion screen (400) on the first display unit, as portrayed in FIG. 4.

Following this, upon activation of a preset import menu on the working hours conversion screen exhibited on the display unit (130), the control unit (150) retrieves one of the stored files from the storage unit (120), based on the user's selection or input. Subsequently, the data contained in the loaded file is displayed on one side of the working hours conversion screen on the display unit (130). These files, which may assume the form of databases such as Excel files or Access files, encompass vital worker information including name, partial social security number, employee code, as well as details regarding daily work hours such as start and end times.

For instance, upon activation of the import menu (410) on the working time conversion screen (400) exhibited on the first display unit, the first control unit promptly initiates the display of a file search interface in the form of a pop-up on the first display unit.

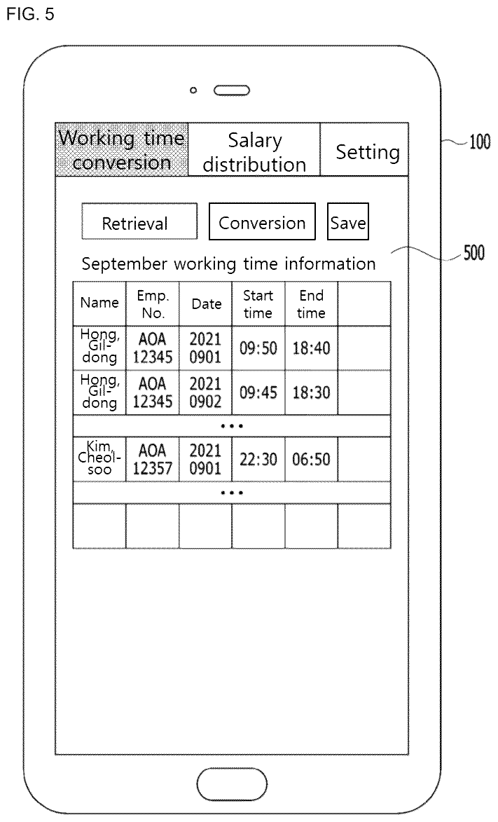

Also, when the user opts for the first file, manifested as an Excel file, among the suite of files exhibited on the aforementioned first display unit, as depicted in FIG. 5, the first control unit attentively presents relevant data (500), encompassing detailed arrival and departure records of individuals like Hong Gil-dong and Kim Cheol-soo for every working day in September 2021, systematically arranged within the first file, on the first display unit (S220).

Subsequent to this, upon selection of a predefined conversion menu on the working time conversion screen displayed on the display unit (130) (or during the display of data from the imported file on the display unit 130), the control unit (150) proceeds to convert the daily working time data. This includes parameters like start and end times, presented in digital display format within the corresponding file, into numerical format, seamlessly integrating it into the working time conversion screen.

Specifically, upon selection of the designated conversion menu within the working time conversion interface on the display unit (130), the control unit (150) initiates the calculation of numerical working hours based on the digital-format daily arrival and departure times for each employee outlined in the imported file, utilizing the procedures specified in [Equation 1] and [Equation 2].

Also, should the calculation of working hours result in a negative figure, a situation often arising from night shifts or prolonged work periods where the recorded departure time deviates from conventional schedules, the control unit (150) applies a predetermined corrective value (for instance, 24 hours) to amend the negative outcome, thereby ensuring the accuracy of the total working hours computation.

Likewise, when encountering instances that lead to negative working hours calculations due to shifts extending into the next calendar day or overtime labor, necessitating departure times to be logged after the start date, the control unit (150) amends the computational approach by modifying the established equations detailed in [Equation 1] and [Equation 2], thereby facilitating an accurate reflection of actual working hours.

This approach enables the control unit (150) to accurately compute the working hours as per the equations [Equation 1] and [Equation 2], catering to both daytime and nighttime work scenarios.

Additionally, the control unit (150) performs conversions to express the digital hours and minutes delineated in the work start and end times into numerical format, facilitating seamless integration into the computational (or calculating/converting/switching) processes.

For example, when the conversion menu (420) is activated on the working time conversion interface (400) displayed on the display unit, the control unit meticulously undertakes the conversion task, translating the digital-format data detailing the arrival and departure times for each working day in September 2021 for individuals such as Hong Gil-dong and Kim Cheol-soo, as specified in the initially loaded file, into a numerical format before calculating the working hours for each specific day.

In this conversion process, for an instance where Hong Gil-dong's sign-in time on Wednesday, Sep. 1, 2021, is logged at 09:50 and sign-out time at 18:40, both in digital format, the control unit precisely computes Hong Gil-dong's work duration for that day using the formulas provided in [Equation 1], determining the work hours (e.g., 18−09−1=8 hours) and work minutes (e.g., 60−50+40=50 minutes) by considering the entry minutes (50) exceed the exit minutes (40).

Similarly, for Kim Cheol-soo's check-in at 22:30 on Wednesday, Sep. 1, 2021, and check-out at 06:50 the next day, both in digital format, the control unit applies a similar computational approach with a modified version of [Equation 2] to calculate Kim Cheol-soo's work duration for his first work period (e.g., 24+06−22=8 hours) and the minutes of the same period (e.g., 50−30=20 minutes), noting that the entry minutes (30) are less than the exit minutes (50).

Following these calculations, the control unit (150) proceeds to assess whether any violation of labor standards, as stipulated by preset regulations, has occurred based on the converted daily working hours. These violations may include exceeding the stipulated 40-hour workweek or the 52-hour limit, predicated on an 8-hour workday.

Also, the control unit (150) ensures transparency by displaying information regarding compliance with or violations of the Labor Standards Act, along with details of the converted daily working hours, on the display unit (130).

In scenarios where no violations of the Labor Standards Act are detected, the control unit (150) promptly updates and presents information indicating compliance status, along with details of the converted daily working hours, on the working time conversion screen.

Also, if violations of the Labor Standards Act are identified, the control unit (150) promptly updates and showcases information regarding the violations, accompanied by details of the converted daily working hours, on the working time conversion screen.

For example, the first control unit conducts a thorough assessment to determine whether violations of the Labor Standards Act have occurred based on the converted daily working hours pertaining to individuals such as Hong Gil-dong and Kim Cheol-SOO.

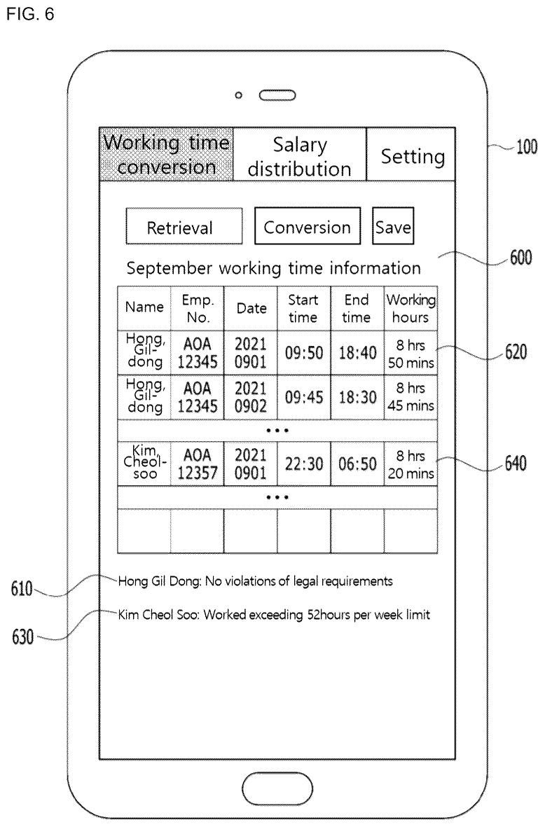

Also, in the event that the determination yields no violation of the regulations mandated by the Labor Standards Act concerning Hong Gil-dong, as illustrated in FIG. 6, the first control unit promptly updates the information (610) signifying compliance, along with the computed daily work hours (620) attributed to Hong Gil-dong, on the working time conversion screen. Subsequently, these updates are displayed on the primary display unit.

Similarly, upon the conclusion of the aforementioned assessment, if a violation of the Labor Standards Act is detected in connection with Kim Cheol Soo, as depicted in FIG. 6, the first control unit promptly amends the records to indicate non-compliance, specifying the infringement (e.g., exceeding 52 hours per week) (630), alongside the recalculated daily work hours (640) attributed to Kim Cheol Soo, on the working time conversion screen. These updates are then presented on the primary display unit (S240).

Also, upon selection of a predefined salary distribution menu from the application execution result screen showcased on the display unit (130), the control unit (150) initiates the display of a salary distribution interface designed to automatically allocate wages based on an employee's age category and overtime hours, in accordance with their respective working hours. This salary distribution interface comprises a worker information input section for displaying pertinent employee details, a total monthly salary input section for inputting the overall monthly salary, an overtime input section for entering overtime hours, multiple wage items calculated automatically through a circular reference function utilizing the total monthly salary and overtime, and a legality violation section for indicating compliance with the Labor Standards Act. Moreover, if another file is selected from those stored in the storage unit (120), the control unit (150) automatically loads and presents the worker information from the selected file in the corresponding input section. Furthermore, the control unit (150) automatically computes the overtime hours based on the numerical daily work hours for each employee contained in the selected file, and subsequently displays or inputs these calculated overtime hours in the designated input section.

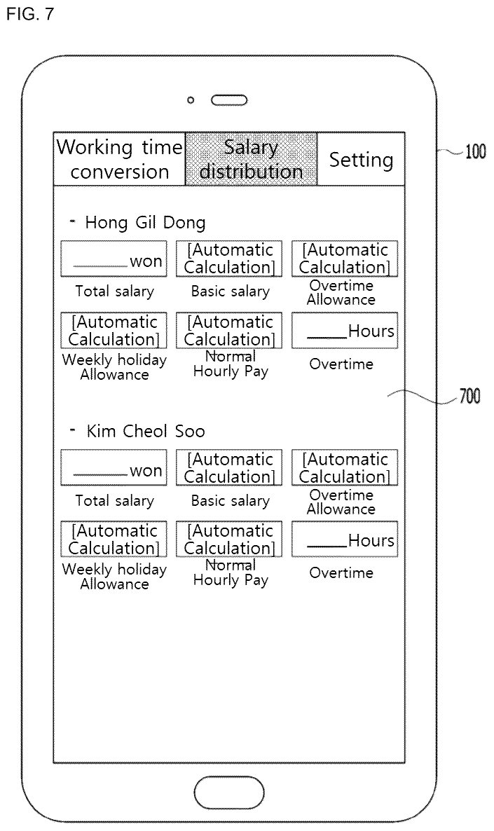

For instance, upon selecting the salary distribution menu (320) from the payroll management app execution result screen (300) displayed on the primary display unit, as depicted in FIG. 7, the first control unit proceeds to exhibit the corresponding salary distribution screen (700) on the primary display unit (S250).

Subsequently, after user input of the total monthly salary and overtime into the respective input fields within the salary distribution screen (or upon automatic input of overtime following user input of the total monthly salary), the control unit (150) engages a circular reference function to automatically allocate wages by age category based on the user-provided inputs, utilizing Equations 3 to 6. Notably, this encompasses various wage components such as basic wage, overtime allowance, weekly allowance, and regular hourly wage.

In practice, when the user inputs the gross monthly salary and overtime into the designated fields within the salary distribution screen (or when overtime is automatically inputted and subsequently the gross monthly salary is entered), the control unit (150) computes the corresponding wage components for each worker included in the imported file, employing Equations 3 to 6.

Also, the control unit (150) undertakes a scrutiny (or assessment) to ascertain any potential violations of other regulations mandated by the pre-established Labor Standards Act, considering factors such as the total monthly salary, overtime, and the multitude of wage components. These assessments encompass adherence to regulations regarding regular hourly wages, such as the minimum wage set at 8,720 won as of 2021.

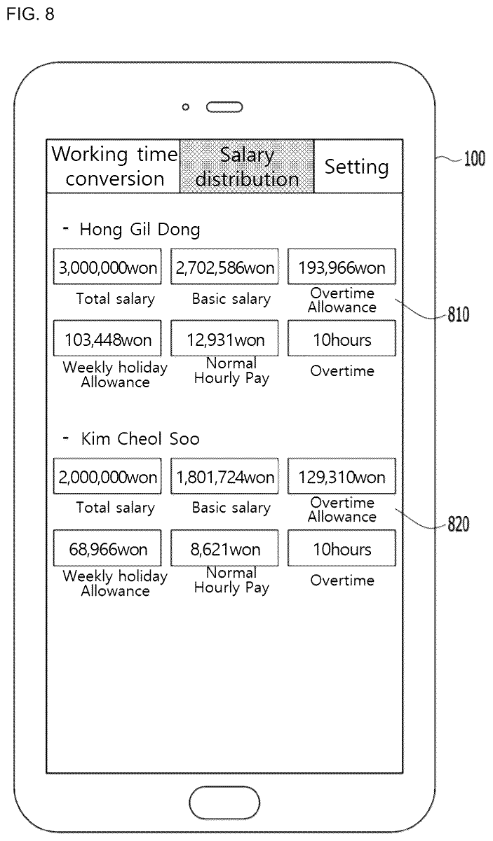

For instance, when a user enters the initial gross monthly salary (e.g., 3 million won) and initial overtime (e.g., 10 hours) for Hong Gil-dong, and likewise, the 101st gross monthly salary (e.g., 2 million won) and the 101st overtime (e.g., 10 hours) for Kim Cheol-soo, the first control unit applies Equations 3 to 6 to accurately compute and allocate Hong Gil-dong's first basic salary, first overtime compensation, first weekly earnings, and first standard hourly wage (810); in parallel, it calculates and allocates Kim Cheol-soo's 101st basic salary, 101st overtime pay, 101st weekly compensation, and 101st hourly rate (820), as illustrated in FIG. 8.

Additionally, the primary control unit assesses whether there are any further infringements of the regulations mandated by the Labor Standards Act, based on the allocated Gross Monthly Salary (e.g., 3 million won) and initial overtime (e.g., 10 hours) pertaining to Hong Gil-dong, alongside the initial basic salary, extension allowance, and standard hourly wage, among others, as well as the 101st Gross Monthly Salary (e.g., 2 million won) and 101st overtime (e.g., 10 hours) linked to Kim Cheol Soo, along with the respective 101st basic salary, extension allowance, weekly allowance, and standard hourly wage (S260).

Subsequently, the control unit (150) exhibits, on the display unit (130), details regarding any potential breaches of laws stipulated by the Labor Standards Act, alongside the salary (or amount) automatically distributed by salary category based on the user-inputted total monthly salary and overtime.

Put differently, in the absence of any other violations of laws required by the Labor Standards Act, the control unit (150) updates and presents information indicating the absence of such violations, alongside the distributed amount allocated by salary category, on the salary distribution screen.

Also, should there be any additional violations of laws mandated by the Labor Standards Act, the control unit (150) updates and showcases information regarding said violations, as well as the corresponding penalty amount allocated by salary category, on the salary distribution screen.

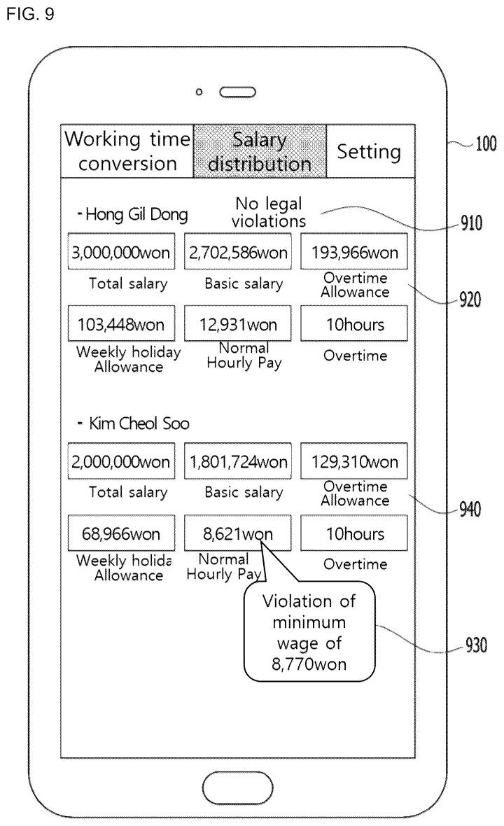

For instance, when no breaches of laws required by the Labor Standards Act are detected in connection with Hong Gil-dong, as depicted in FIG. 9, the primary control unit updates information (910) signaling the absence of further violations, along with the initial basic salary (KRW 2,702,586), extension allowance (KRW 193,966), weekly allowance (KRW 103,448), and standard hourly wage (KRW 12,931) calculated for Hong Gil-dong (920) on the salary distribution screen, which is then displayed on the first display unit.

Also, subsequent to the aforementioned assessment, if there are any additional violations of laws mandated by the Labor Standards Act concerning Kim Cheol Soo, the primary control unit, as illustrated in FIG. 9, updates information indicating such violations (e.g., minimum wage violation) (930), alongside the 101st basic salary (KRW 1,801,724), 101st extension allowance (KRW 129,310), 101st weekly allowance (KRW 68,966), and 101st standard hourly wage (KRW 8,621) (940) calculated for Kim Cheol Soo on the salary distribution screen, and subsequently displays it on the first display unit (S270).

The present invention's embodiments automate salary distribution across categories using a circular reference function informed by user-input total salary and numerically formatted extended time, ensuring automatic allocation doesn't exceed the user's predefined total monthly salary, thus preventing overshooting the anticipated salary budget, while also enabling real-time customization of work hours and salary configurations to user preferences, streamlining setup and empowering self-implementation without the need for expert assistance.

Furthermore, this invention streamlines compliance with the Labor Standards Act by eliminating the need for conversion processes, directly transforming workers' digitally displayed working times into numerically calculated working hours to facilitate complex time calculations beyond 24:00 hours and for varied shifts, allowing for the immediate verification of cumulative work hours on a weekly, monthly, and annual basis without conversions, and integrating diverse numerical time-based formulas seamlessly.

Additionally, embodiments of this invention preemptively identify potential infractions of the Labor Standards Act based on parameters like total salary, numerically converted overtime, and penalties for specific wage items, offering a proactive mechanism to forestall unforeseen legal issues post-setup, thereby providing guidance on adhering to legal mandates effectively.

It should be noted that the aforementioned content is subject to modifications and variations by individuals with ordinary skill in the relevant technical field, without deviating from the core features of the invention. Therefore, the disclosed embodiments serve to illustrate rather than restrict the technical concept of the invention, and the scope of its technical idea is not confined by these embodiments. The protection scope of the invention is determined by the subsequent claims, encompassing all equivalent technical concepts therein.

### Forms for Implementing the Invention

The form for implementing the invention has been elucidated alongside the optimal approach for realizing the invention.

Industrial Applicability: The present invention's capability to automatically allocate salaries for each wage item using a circular reference function, based on the total salary per user input and overtime formatted numerically, ensures industrial applicability. By restricting salary distribution within the user-inputted monthly salary limit, real-time result validation, and user-friendly customization options, the invention significantly streamlines program setup, enabling users to self-configure without requiring expert assistance.

1. An apparatus equipped with a display unit that not only showcases an application execution result screen but also, upon user selection of a specified working time conversion menu from said screen, fetches a user-selected file to present a working time conversion interface for the purpose of transforming digital format working hours into a numeric representation; furthermore, this apparatus, through the activation of a designated import menu on the conversion interface, retrieves and displays content from any one of several files stored within its storage unit on a portion of the conversion interface, and subsequent selection of a conversion menu therein triggers the conversion of displayed digital working time data into numerical hours, incorporating a control unit tasked with evaluating these numerically converted working hours to identify potential Labor Standards Act violations, verify the occurrence of such violations, and exhibit the specific numerical working hours on the display unit.

2. The appartus of claim 1, wherein the control unit, subsequent to the aforementioned determination, controls the display unit to showcase information that highlights the non-violation of the Labor Standards Act, and concurrently manages the exhibition of the numerically converted daily working hours on the display.

3. The apparatus of claim 1, wherein the control unit, subsequent to making the aforementioned determination, regulates the presentation of information concerning any identified violations of the Labor Standards Act and the numerically converted daily working hours on the display unit.

4. The apparatus of claim 1, wherein, upon selection of the working time conversion menu from the application execution result screen, the control unit initiates the process by retrieving a user-chosen file and presents a working time conversion screen on the display unit to enable the conversion of working hours from digital display format to numeric format; subsequently, upon activation of the preset import menu on the working time conversion screen, it accesses one or more files stored in the storage unit based on user selection and exhibits the data from the imported file on one side of the working time conversion screen; upon selection of a preset conversion menu on the working time conversion screen, the control unit transforms the daily working time information in digital format within the displayed file into numerical working hours; moreover, it assesses any Labor Standards Act violations based on the converted daily working hours and displays both potential violations and the converted daily working hours on the display unit, thereby facilitating salary computation.

5. The apparatus of claim 4, wherein the conversion of daily working time information from digital display format to numerical format includes a calculation applied when the value for the arrival time in the working time data surpasses the value for the departure time, represented by the equation: \((c−a−1)\) hours and \((60−b+d) \) minutes, with ‘a’ denoting the clock-in hour, ‘b’ indicating the clock-in minute, ‘c’ representing the clock-out hour, and ‘d’ signifying the clock-out minute.

6. The apparatus of claim 4, wherein the conversion of daily working time information from the digital display format included in the file into a numerical representation of working hours is governed by an equation activated when the value corresponding to the commencement time of the work period within the working time data is less than or equal to the value for the conclusion time of the work period, where ‘a’ and ‘c’ denote the hours at the start and end of work, respectively, and ‘b’ and ‘d’ denote the minutes at the start and end of work, respectively; this process underscores a salary management approach.

7. The apparatus of claim 4, wherein the step of converting daily working time information from digital display format to numeric working time, integral to a salary management method, includes a calculation that accounts for situations where the working time, as specified in the working time data, varies due to night or overtime work, leading to a negative value; in these instances, a predetermined value is added to the negative working time to determine the sum as the total working time.

8. The apparatus of claim 1, wherein, when a preset salary distribution menu is selected from the application execution result screen, the salary management device presents a salary distribution screen to automatically allocate salaries by category using a circular reference function based on each worker's overtime hours and total monthly salary; this includes a control unit that not only automates salary distribution according to user-input total monthly salary and overtime but also verifies compliance with the Labor Standards Act's requirements, simultaneously displaying details of the salary allocated by category per the user's input and signaling any detected legal violations as mandated by the Labor Standards Act on the display unit.

9. The apparatus of claim 1, wherein, when a preset salary distribution menu is selected from the application execution result screen, the control unit unveils a salary distribution screen that streamlines the allocation of salaries into by-salary categories through a circular reference function applied to overtime and total salary, informed by each worker's working hours; upon entering the total monthly salary and overtime in the specified fields on this screen, the control unit, utilizing the circular reference method, seamlessly distributes the salary by wage item and concurrently assesses any potential legal breaches as stipulated by the Labor Standards Act, examining elements like total monthly salary, overtime, and set wage items, with ensuing display of information concerning the salary distribution to by-salary categories according to user inputs and any detected legal infractions mandated by the Labor Standards Act on the display unit.

10. The apparatus of claim 9, wherein the automatic distribution of salary to the by-salary category via the circular reference function includes the calculation of various salary components such as basic salary, overtime allowance, weekly allowance, and normal hourly pay; this calculation entails subtracting the total monthly salary, overtime allowance, weekly allowance, and the overtime hourly wage multiplied by 1.5 for weekly holiday allowance, and further subtracting the overtime hourly wage multiplied by 8.
